(19) United States
(12) Patent Application Publication
(10) Pub. No.: US 2013/0116104 A1
(43) Pub. Date: May 9, 2013

(54) Centrifuge Bucket

(71) Applicants: Heinz-Gerhard Koehn, Hamburg (DE); Eckart Kopowski, Braunschweig (DE); Sylke Grune, Chemnitz (DE); Sandra David, Hamburg (DE); Ulrike Gaebler, Leipzig (DE); Paul Chatzis, Karlsbad (DE)

(72) Inventors: Heinz-Gerhard Koehn, Hamburg (DE); Eckart Kopowski, Braunschweig (DE); Sylke Grune, Chemnitz (DE); Sandra David, Hamburg (DE); Ulrike Gaebler, Leipzig (DE); Paul Chatzis, Karlsbad (DE)

(21) Appl. No.: 13/461,531

(22) Filed: May 1, 2012

Related U.S. Application Data
(60) Provisional application No. 61/518,197, filed on May 2, 2011.

(51) Int. Cl. B04B 7/08

(52) U.S. Cl. CPC B04B 7/08
USPC 494/60

(57) ABSTRACT

A centrifuge bucket for centrifuging materials, in particular in laboratory centrifuges. The centrifuge bucket is operable in a very simple manner and facilitates safe and constant closure over the service life of the centrifuge bucket. Thus, the centrifuge bucket handles much better than known centrifuge buckets because real one hand operation without using a second hand is facilitated. Furthermore, the centrifuge bucket can be produced in a simpler and more cost-effective manner while being equally suitable for a given centrifugation power and centrifugation capacity.

### RELATED APPLICATIONS

This application claims priority from and incorporates by reference U.S. provisional patent application 61/518,197 filed on May 2, 2011.

### FIELD OF THE INVENTION

The present invention relates to a centrifuge bucket including a container, a cover, at least one handle arranged at the cover and closure devices corresponding to one another that are arranged respectively at the handle and at the container so that a clamping force is generated in a closed condition of the centrifuge bucket and the cover is pressed onto the container.

### BACKGROUND OF THE INVENTION

Centrifuge buckets of this type are used for centrifuging materials in particular in lab centrifuges where very high speeds are being used. Containers with various shapes and sizes are used in centrifuge buckets, for example, test tubes or micro plates in which the materials to be centrifuged, for example, liquid samples are disposed. It has to be prevented during the centrifugation process that these containers fall out or are thrown out or material escape occurs. For these reasons centrifuge buckets are provided with a cover. It is furthermore required that the centrifuge bucket sits safely on the container of the centrifuge bucket over the entire operating range of the centrifuge, thus also under high speeds.

For this purpose a centrifuge bucket is known from EP 0 025 945 A1 in which a snap locking connection is provided between the cover and the container, wherein the snap locking connection is provided in the form of protrusions with opposite orientations. This configuration has the disadvantage that frequent opening and closing causes material fatigue whereby a safe and tight closure of the centrifuge bucket can no longer be guaranteed.

DE 8 415 715 U1 illustrates a centrifuge bucket in which clamps are provided that are evenly spaced along the cover and which can be brought into engagement with protrusions at the bucket edge. The disadvantage of this configuration is that opening and closing the centrifuge bucket requires a high level of attention.

DE 1 0128 539 A1 includes further development of this configuration where lever handles are arranged at the cover, wherein the lever handles include cams which can be brought into operative engagement with guiding groves which are provided as protrusions at the container. Thus simplified handling is guaranteed. However, it is still required to first place the cover onto the container, to center it and to press it into contact, before the cams of the levers can be inserted into the support grooves. Thus, real one hand operation is not feasible.

In another further development according to DE 10 2008 031 502 A1 the lever includes guide elements which engage a guide track of the bucket, wherein a horizontal clamping force component is generated in addition to the vertical clamping force component pressing the cover onto the container in order to safely center the cover on the container. It is a disadvantage of this configuration that the contours of the guide track and of the guide element are configured in a very complex manner and their engagement over a period of time causes the contours to grind into one another, which causes a decrease of the clamping.

### BRIEF SUMMARY OF THE INVENTION

It is an object of the present invention to provide a centrifuge bucket which is operable in a manner that is as easy as possible and facilitates easy closure over the service life of the centrifuge bucket, wherein handling of the centrifuge bucket shall be improved. In particular the centrifuge bucket shall be producible in a simpler and therefore more cost effective manner while equally suitable for a particular centrifugation efficiency and centrifugation capacity.

This object is achieved according to the invention through a centrifuge bucket including a container, a cover, at least one handle arranged at the cover and closure devices corresponding to one another that are arranged respectively at the handle and at the container so that a clamping force is generated in a closed condition of the centrifuge bucket and the cover is pressed onto the container. The at least one handle includes at least one first closure device which interacts with at least one second closure device arranged at the container to provide the clamping force for closing the centrifuge bucket, at least one first closure device is arranged at the at least one handle is configured as a guide track and the at least one second closure device arranged at the container is configured as a guide element, and the guide element is engageable in the guide track to provide the clamping force. Advantageous embodiments are provided in following features that may be included individually or in any combination with the above centrifuge bucket:
the at least one handle is configured detachable from the cover;
the at least one handle rotates about a first rotation axis relative to the cover which differs from a second rotation axis of the at least one handle relative to the container, and the first rotation axis of the at least one handle at least in open condition of the centrifuge bucket is arranged relative to the cover with reference to a longitudinal extension of the centrifuge bucket above the second rotation axis of the at least one handle relative to the container;
the at least one handle is supported at two rotation points at the cover, and the corresponding closure devices at the container and at the at least one handle are associated with each rotation point and/or the at least one handle is configured as a pivotable lever;
the at least one handle is rotatable into a position in which the centrifuge bucket is closed and the at least one handle is usable as a carrying handle;
the at least one handle includes a stop which acts in a first rotation direction and prevents a rotation of the at least one handle beyond the stop in the first rotation direction;
the stop is configured so that it provides a force component when the at least one handle is rotated against the stop, and the force component is oriented opposite to the clamping force in order to disengage the cover from the container;
the centrifuge bucket includes locking devices for locking the at least one handle in the closed condition of the centrifuge bucket;
the locking devices are configured at the cover, so that the at least one handle is engageable with at least one additional element of the cover in a friction locking and/or form locking manner; and
the container includes an edge enveloping the cover in a closed condition of the centrifuge bucket, and the edge of the container has a contour that expands conically towards the cover and/or the cover includes a contour that tapers conically in a direction towards the container.

The invention relates to a centrifuge bucket which includes a container and a cover, wherein the container and the cover include corresponding closure devices, so that a clamping force is generated in closed condition of the centrifuge bucket, so that the cover is pressed onto the container, wherein at least one handle is arranged at the cover which includes first closure devices which correspond with second closure devices which are arranged at the container, wherein the first and second closure devices are configured to provide the clamping force through engaging the first and the second closure devices with one another, characterized in that the handle includes at least one guide track and at least one guide element is arranged at the container which can be brought into engagement with the guide track to provide the clamping force.

Thus, it is achieved on the one hand side that the centrifuge bucket is closeable in a simple and permanent manner, wherein the closure is provided over the complete service life of the centrifuge bucket in a constant manner with respect to its closure quality. By providing a respective seal between container and cover furthermore aerosol tight closure can be provided. On the other hand side the centrifuge bucket can be handled much easier than prior art centrifuge buckets because through depressing the handle the guide track of the handle captures the guide element of the container so that a forced closure of the centrifuge bucket is provided. In particular for the centrifuge buckets of DE 1 0128 539 A1 and DE 10 2008 031 502 A1 the handle can only be actuated when the cover is pressed previously onto the container by hand. In the centrifuge bucket according to the invention an engagement of guide track and guide element is achieved by pressing down the handle and thus furthermore the cover is automatically pressed onto the container. This facilitates real one hand operation.

This can be improved in particular in that the handle is configured as a pivotable lever.

Furthermore the centrifuge bucket can be configured much simpler and therefore cost effective for the same centrifugation material capacity and centrifugation efficiency. The reason is that contrary to prior art centrifuge buckets no particular receptacle for the handle has to be provided in the cover as also will be apparent from an advantageous embodiment. Consequently the cover can be configured for a lower load bearing capability than would be required for pivot bearings integrated in the cover. Consequently the cover can also be configured much flatter so that substantial installation space advantages are achieved. Thus, overall the container of the centrifuge bucket can be configured larger so that with respect to a standard centrifuge more space is provided for receiving material to be centrifuged.

In a particularly useful manner the handle is configured so that it is detachable from the cover because then the cover can be cleaned in a very simple manner and cost-effective replacement can also be provided in case of defects.

In a particularly advantageous embodiment the handle has a rotation axis relative to the cover which is arranged eccentric relative to the rotation axis of the handle relative to the container. It is particularly preferred that at least in open condition of the centrifuge bucket the rotation axis of the handle relative to the cover is arranged with reference to the longitudinal extension of the centrifuge bucket above the rotation axis of the handle relative to the container. This causes very effective clamping of the cover relative to the container during actuation of the handle, wherein this configuration is particularly simple.

When the handle is supported at two pivot points at the cover and corresponding closure devices at container and handle are associated with each rotation point, a particularly uniform clamping can be achieved both for circular and rectangular cross sections of the centrifuge bucket.

It is particularly advantageous when the handle includes a stop acting in one rotation direction. This ensures that the handle is not over-rotated and on the other hand side a particular position of the handle is indicated through the stop, wherein this advantageously is the opening position. For example the stop can be configured as a lug or similar that is fixed at the handle, wherein the lug is rotatable together with the handle about the rotation axis of the handle and abuts the stop position of the container.

In a particularly advantageous embodiment the stop is configured so that it provides a force component when the handle is rotated against the stop, wherein the force component acts contrary to the clamping force to disengage the cover from the container. This facilitates in a particularly simple manner that the cover of the centrifuge bucket can be disengaged from the container easily also when a vacuum has been created in the centrifuge bucket through centrifugation or the seals of the container and the cover adhere to one another.

Thus, it is advantageously provided that the stop is arranged so that the first and the second closure devices of container and cover can be taken out of engagement in the position where the stop engages the container. In this case the stop position marks the opening position of the centrifuge bucket at the same time.

However it can also be alternatively provided that no opening of the centrifuge bucket is feasible in the stop position. This provides securing the cover during transportation of the centrifuge bucket. For example it can be provided that the handle configured as a pivotable lever closes the centrifuge bucket in a horizontal position (for example 0°), in the vertical position (approximately 90°) the cover is secured relative to the container so that the centrifuge bucket can be carried at the handle, while the engagement devices can be brought out of engagement in an intermediary position (for example 70°) between the horizontal and vertical position in order to remove the cover from the container. In a position (for example 100°) further exceeding the vertical position the stop position can be provided in which the cover is removed from the container under the impact of force.

In another alternative configuration the opening position is provided, for example, in a horizontal position and the closed position is provided in the other horizontal position, wherein a support position is provided in the vertical position in which a safe closure of the centrifuge bucket is simultaneously provided.

In order to provide a safe closure also in an operating position during centrifugation it is advantageously provided that locking devices are provided at the centrifuge bucket for the handle in closed condition. These locking devices which can also be a single locking device can thereby be arranged at the container and also at the cover. It is advantageously provided that at least one engagement lug or similar is provided at the cover, wherein the handle can be brought into frictional engagement and/or form locking engagement with the engagement lug. Thus, undesirable opening of the handle is effectively prevented.

Reliable centering of the cover on the bucket is advantageously provided in that the container includes an edge that at least partially reaches around the cover in closed condition of the centrifuge bucket, wherein it is advantageously provided that the edge of the container includes a contour that conically expands towards the cover and/or the cover includes a contour that conically tapers towards the container.

### BRIEF DESCRIPTION OF THE DRAWINGS

The features and advantages of the present invention are now described in more detail based on an advantageous embodiment with reference to drawing figures, wherein:

FIG. 1 illustrates the centrifuge bucket according to the invention in a perspective overall view of a first advantageous embodiment;

FIG. 2 illustrates a detail of the centrifuge bucket according to FIG. 1 in closed condition;

FIG. 3 illustrates a detail of the centrifuge bucket according to FIG. 1 during an opening process;

FIG. 4 illustrates a detail of the centrifuge bucket according to FIG. 1 in the opening- and stop position;

FIG. 5 illustrates the cover of the centrifuge bucket according to FIG. 1 without handle;

FIG. 6 illustrates the handle of the cover according to FIG. 5;

FIG. 7 illustrates the cover of the centrifuge bucket according to FIG. 1 with a handle;

FIG. 8 illustrates a detail of the centrifuge bucket according to FIG. 1; and

FIGS. 9 to 14 illustrate the centrifuge bucket according to the invention in a second preferred embodiment.

### DETAILED DESCRIPTION

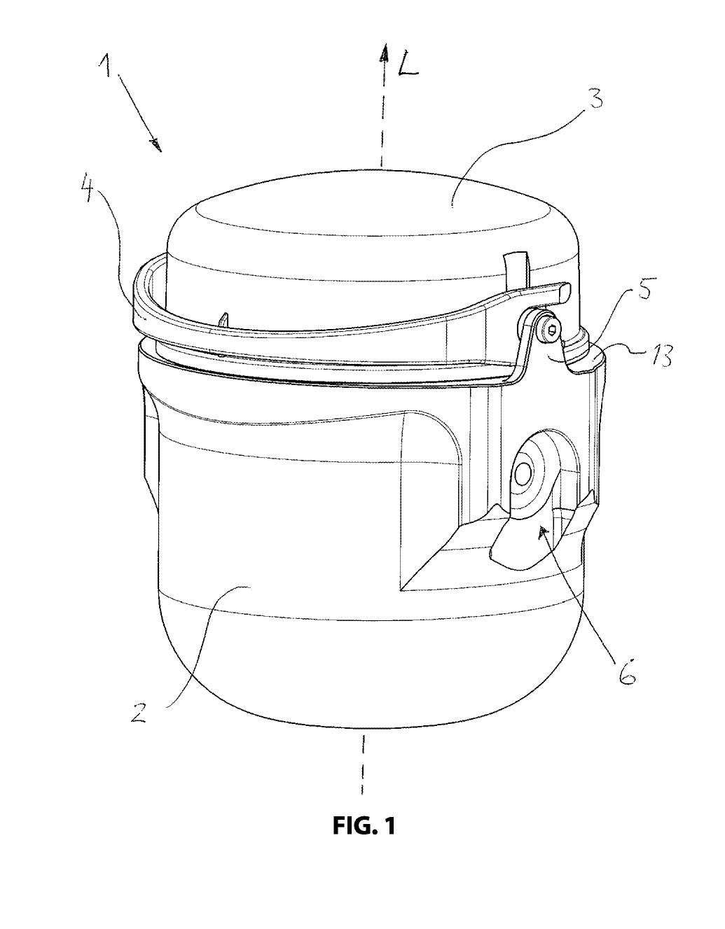

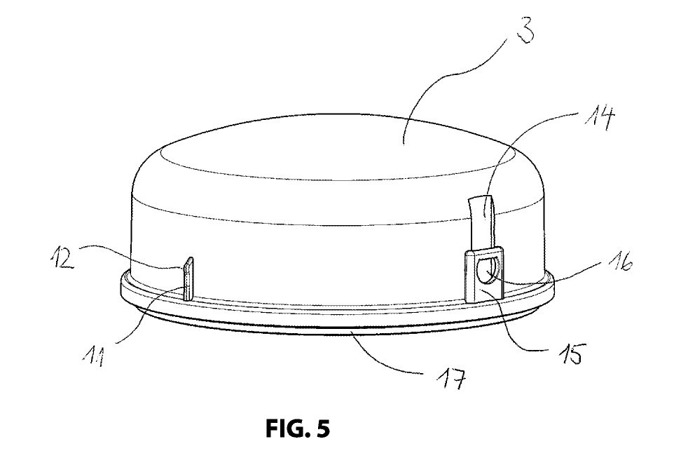

In FIGS. 1 to 8, a first advantageous embodiment of the centrifuge bucket 1 is illustrated in a schematic manner. FIGS. 1 to 4 and 8 thus illustrate the centrifuge bucket 1 in a condition in which the cover 3 is placed on the container 2. FIGS. 5 to 7 illustrate component parts of the centrifuge bucket 1.

It is apparent that the centrifuge bucket 1 includes a container 2 and a cover 3 attachable thereon and has a longitudinal extension L. The centrifuge bucket 1 includes an arched handle 4 and two cantilevers 5 are arranged at the container 2. Additionally, the container 2 includes a recess 6 through which the centrifuge bucket 1 can be coupled and fixated with the rotor (not illustrated) of a centrifuge (not illustrated).

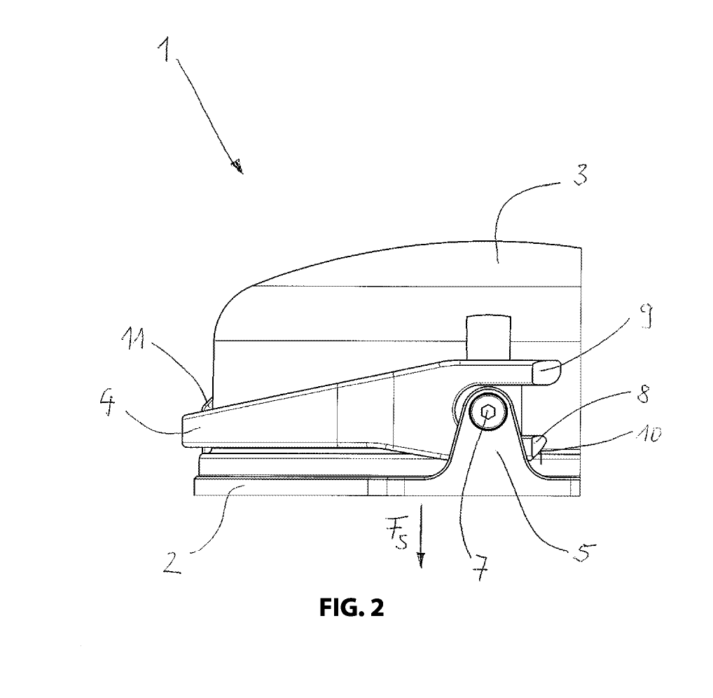

FIG. 2 illustrates an enlarged detail of the centrifuge bucket according to FIG. 1. It is apparent that a pivot bearing 7 is arranged at the cantilever 5, wherein the handle 4 is attached at the pivot bearing 7. Furthermore, the handle 4 includes two lugs 8, 9, wherein one lug 8 has a bevel 10 and the other lug 9 protrudes from the handle 4 in radial direction with respect to the pivot bearing 7. It is furthermore apparent that a protrusion 11 for locking the handle 4 in the horizontal position illustrated in FIG. 2 is arranged at the cover 3, thus in a position of the handle that is perpendicular to the longitudinal extension L of the centrifuge bucket 1.

In this horizontally fixated position of the handle 4, the cover 3 is locked relative to the container 2, wherein the locking force F_{S} is provided through clamping the cover 3 relative to the container 2. This is the configuration in which the centrifuge bucket 1 is closed. When suitable seals (not illustrated) are provided between the container 2 and the cover 3, an aerosol tight closure is also assured under high load during centrifugation. This closure is also particularly uniform with respect to its closing effect due to the centering measures to be described infra and is not only suitable for the illustrated centrifuge bucket 1, but also for other profiles, for example, a rectangular profile.

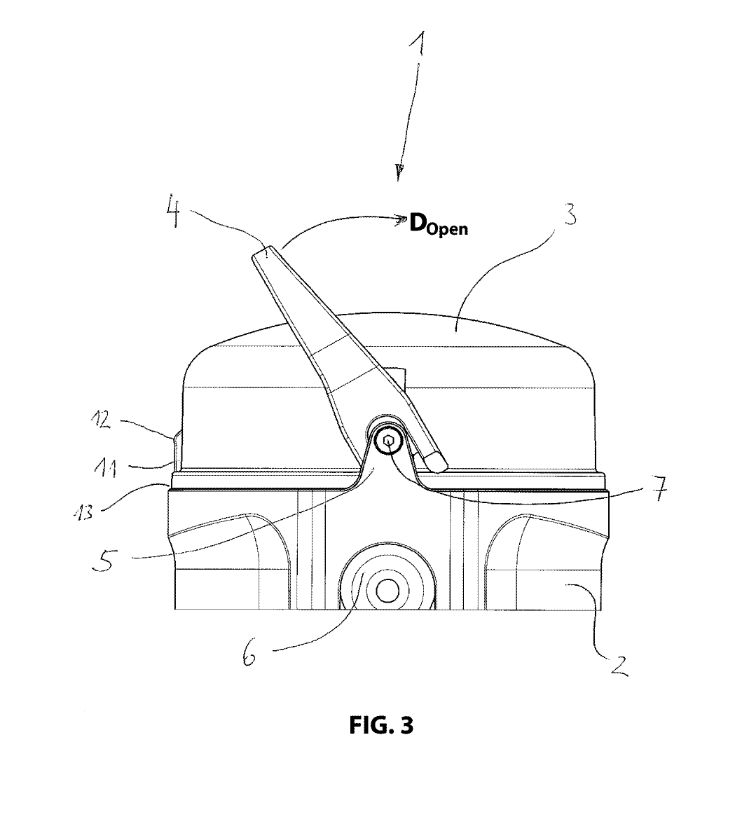

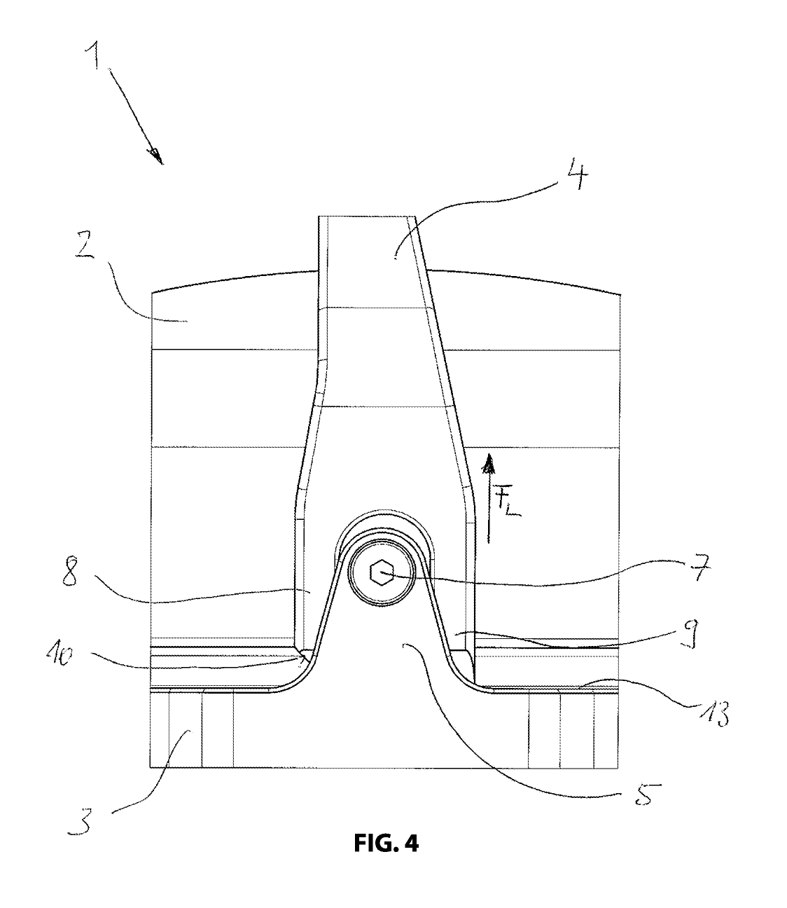

In FIG. 3, the centrifuge bucket 1 according to the invention is illustrated in a condition in which the handle 4 has been moved from the closed position illustrated in FIG. 2 into an open position illustrated in FIG. 4. It is apparent that raising the handle 4 overcomes the fixation of the handle 4 caused by the lug 12 at the protrusion 11. Therefore the handle 4 advantageously also includes a protrusion (not illustrated) with which the lug 12 can be brought into frictional engagement. When raising the handle 4, by means of the bevel 10 the shorter lug 8 passes below the pivot bearing 7 being provided at the container 2.

Since the cantilevers 5 together with the pivot bearing are arranged at the container 2 above the respective recesses 6, a significant stiffening of the container 2 is provided based on the material accumulation associated therewith. This stiffening advantageously provides favorable stress distribution or stress redirection in a load case, so that the risk of the centrifuge bucket 1 failing above the support location in the centrifuge provided through the recess 6 is significantly reduced.

FIG. 4 illustrates the open position of the handle 4, thus the position in which the centrifuge bucket 1 can be opened. It is apparent that the handle 4 in this position is parallel to the longitudinal extension L of the centrifuge bucket 1, thus arranged vertically. It is furthermore evident that the longer lug 9 in this position is in contact with the circumferential edge 13 of the bucket 2. Thus, on the one hand side, a stop position is provided so that the handle 4 cannot be pivoted further around the pivot bearing in the opening rotation direction Dₒₚₑₙ. Simultaneously, rotating the handle 4 in opening direction Dₒₚₑₙ against the stop provided through contact of the lug 9 at the edge 13 causes a force component F_{L} which acts essentially vertically in upward direction and against the closing force F_{S}, so that the cover 3 is disengaged from the container 2 in an ergonomically simple manner.

FIG. 5 illustrates the cover 3 of the centrifuge bucket 1 according to FIG. 1 without the handle 4 in a purely schematic manner. It is apparent that the cover 3 includes recesses 14 that are undercut like a dovetail in which respectively a support element 15 for pivotable support of the handle 4 is arranged. In this regard, the support element 15 includes a recess 16 that is configured as a partial circle. The support element 15 is integrally connected with the cover 3. For example, the entire cover 3 can be made as an injection molded component from an injection moldable plastic material and similar. Since the entire complex cover mechanism is then produced through injection molding, this solution is particularly simple and cost-effective and thus also much less error-prone than prior art configurations in which the cover is typically produced from aluminum through a milling process.

It is furthermore apparent that the cover 3 includes a circumferential edge 17 which includes a conically tapering contour. This conically tapering contour 17 corresponds to a conically expanding edge (not illustrated) of the container 2, and when the cover 3 is placed on the container 2 (c.f. FIG. 1), the edge 13 of the container 2 reaches around the edge 17 of the cover 3. This measure then achieves a particularly simple and repeatable centering of the cover 3 on the container 2, so that a safe starting position for closing as well as a safe closure is assured also for one hand operation of the centrifuge bucket 1.

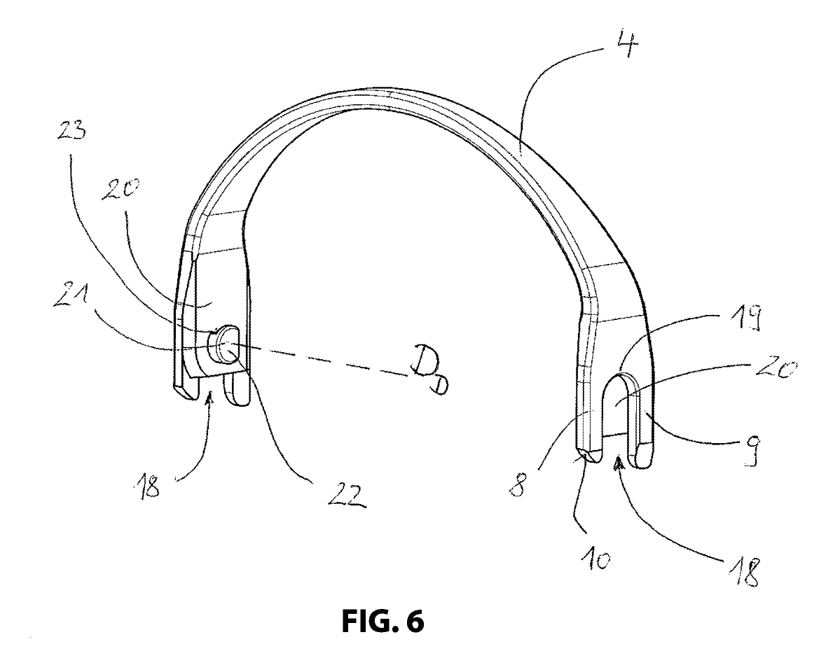

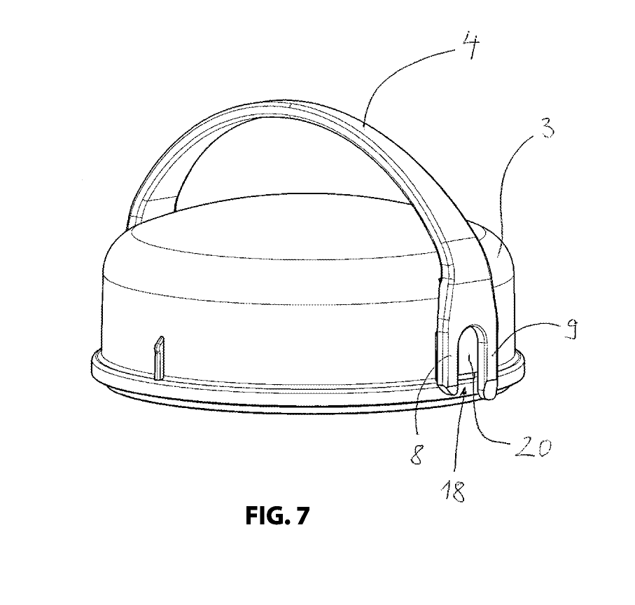

FIG. 6 schematically illustrates the handle 4. It is apparent that the handle 4 includes a guide track 18 which is configured open on one side in a plane parallel to the longitudinal extension L of the centrifuge bucket 1, wherein the guide track 18 is defined in this plane by the lugs 8 and 9 and a round cutout portion 19 of the handle 4. In a plane perpendicular to this plane, the guide track 18 is defined on one side through a plate 20 and is configured open on the opposite side. A bolt element 21 is arranged on the backside of the plate 20, wherein the inner cross-sectional surface 22 of the bolt element is slightly undersized relative to the cross-sectional surface of the recess 16 of the support element 15 of the cover 3. Furthermore, the bolt 21 includes an undercut 23 so that the bolt 21 can be inserted into the recess 16 and locked. The handle 4 can be inserted into the recess 16 through its internal tension based on its arcuate shape and is safely supported therein. This means even when this joining position is reached through rotating the handle 4 the handle 4 cannot skip out of this recess 16. This condition is illustrated in FIG. 7. Thus, the handle 4 includes a rotation axis D_{D} relative to the cover 3.

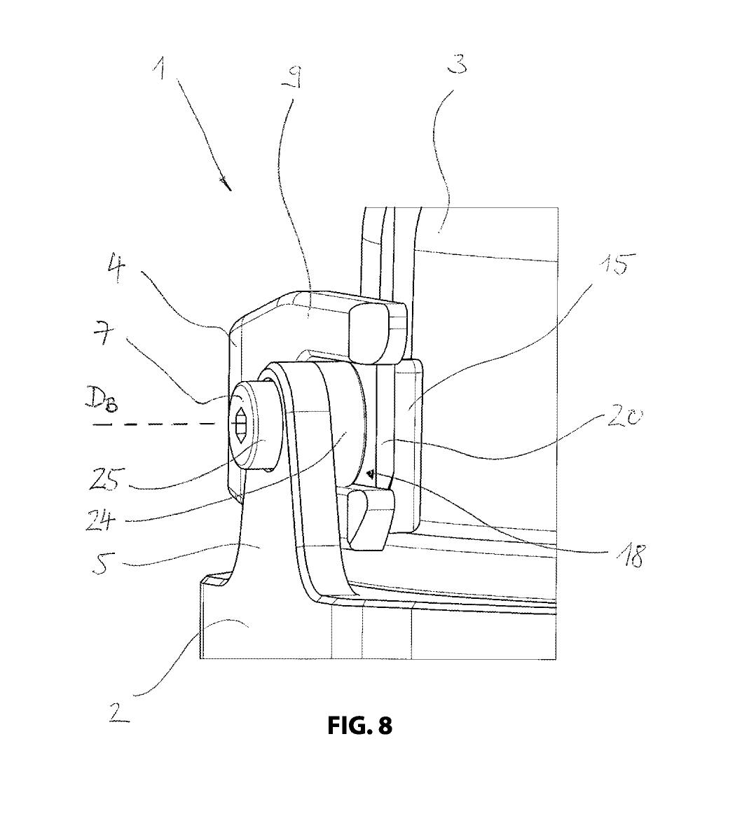

FIG. 8 illustrates the interaction of cover 3, handle 4 and bucket 2 in more detail. It is apparent that the pivot bearing 7 includes a guide element 24 and a fixation element 25 to fixate the pivot bearing 7 at the cantilever 5. The guide element 24 is pivotably arranged at the cantilever 5 through a suitable bearing which helps to minimize friction forces.

It is furthermore evident that the guide element 24 is slightly undersized with respect to the width of the guide track 18 between the lugs 8, 9 which facilitates easy insertion of the guide element 24 into the guide track 18. The guide element 24 defines a rotation axis D_{B} at the container 2 for the handle 4. The rotation axes D_{D} and D_{B} are arranged eccentric relative to one another, wherein the rotation axis D_{D} of the handle 4 relative to the cover 3 in the open condition illustrated in FIG. 4 is vertically above the rotation axis D_{B} of the handle 4 relative to the container 2. Thus, the clamping between the cover 3 and the container 2 is generated when the handle 4 is pivoted into the horizontal position illustrated in FIG. 2.

The plate 20 forms an axial inner stop for the guide element 24 with reference to the rotation axis D_{B} of the handle relative to the container 2, wherein the plate 20 and the guide element 24 are arranged so that they do not touch in the centered condition of the cover 3 on the container 2 in order to minimize frictional forces.

Subsequently closing and opening the centrifuge bucket 1 shall be described in more detail.

Closing the container 2 with the cover 3 is provided in that the cover 3 with the handle 4 is placed on the container 2 so that the guide elements 24 engage the corresponding guide tracks 18. Then, the handle 4 is pressed down against the direction of the longitudinal extension L of the centrifuge bucket 1 which automatically facilitates centering the cover 3 relative to the container 2. Thus, the guide tracks 18 act in combination with the cantilevers 5 or the guide elements 24 as centering aid which is supported by the edges 13, 17 that are configured with opposite cones which engage one another. When the handle 4 is pressed down it is simultaneously pivoted and thus moved continuously, first into the position illustrated in FIG. 3 and subsequently into the horizontal position illustrated in FIG. 2 in which the handle interlocks at the lug 12 so that it is fixated.

During opening the handle 4 is gripped in the horizontal position illustrated in FIG. 2 and raised which releases the fixation through the lug 12. Subsequently, the handle 4 is continuously moved into the position illustrated in FIG. 3 and subsequently moved into the vertical position illustrated in FIG. 4. Therein, the lug 9 contacts the bucket edge 13 which provides a disengaging force component F_{L} acting against the closing force F_{S}, wherein the disengaging force component F_{L} disengages the cover in an ergonomic and easy manner from the container 2, even when there is a vacuum in the centrifuge bucket or the seals (not illustrated) of the container 2 and the cover 3 stick together. In the position illustrated in FIG. 4, the cover can be easily lifted off from the container in order to remove the centrifuged material.

Alternatively it can also be provided that the cover 3 cannot be removed in the vertical position of the handle 4. This is helpful, for example, when the centrifuge bucket 1 shall be transported in closed condition suspended at the handle 4. Thus, it could be achieved that the support track 18 in the vertical position of the handle 4 does not extend in a vertical manner as well, but at a slant angle. When the stop 9 is only provided in a position after the vertical position of the handle 4, the centrifuge bucket 1 can be carried at the handle which is in the vertical position and after moving the handle into the stop position in order to generate the force component Fₛ, removing the cover from the container 2 is possible.

Instead of the lever shaped handle 4 with two guide tracks 18 also a handle with only one guide track can be provided. Then the cover can be pivotably arranged at the container through a hinge on the upper side of the handle. This hinge on the one hand side can be configured through two hinge components that are detachable from one another; on the other hand, it can also be configured through two hinge components that are permanently connected with one another. A disengageable hinge, however, would be preferable because the cover then could be separated from the container.

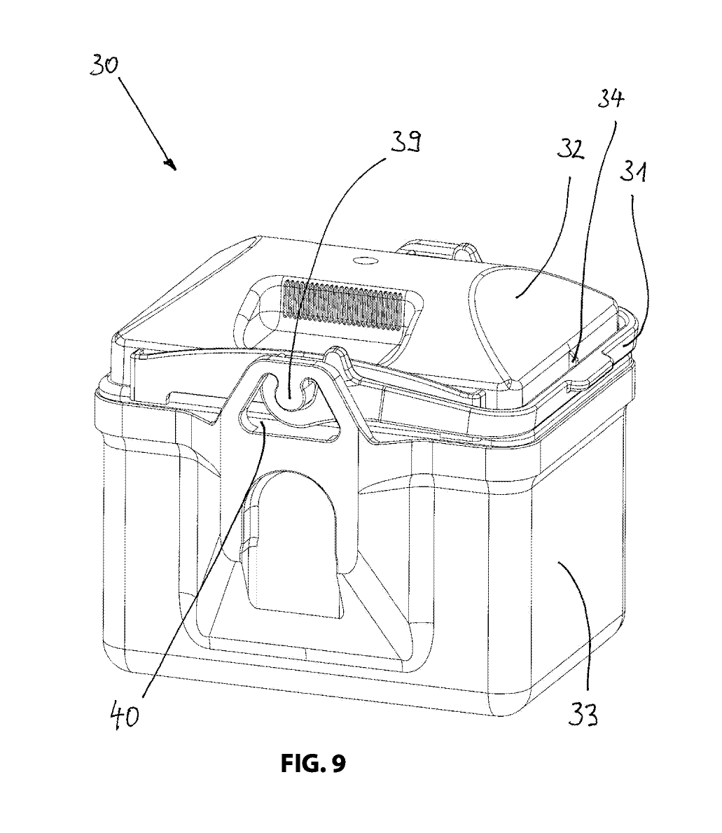

FIGS. 9 through 14 illustrate a second advantageous embodiment of the centrifuge bucket 30 according to the invention schematically in various positions of the handle 31.

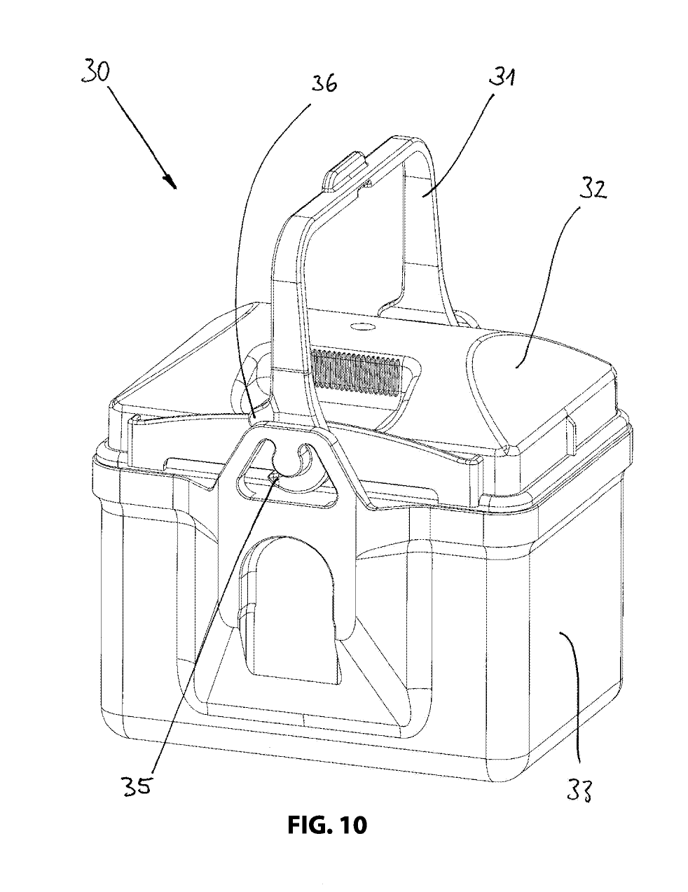

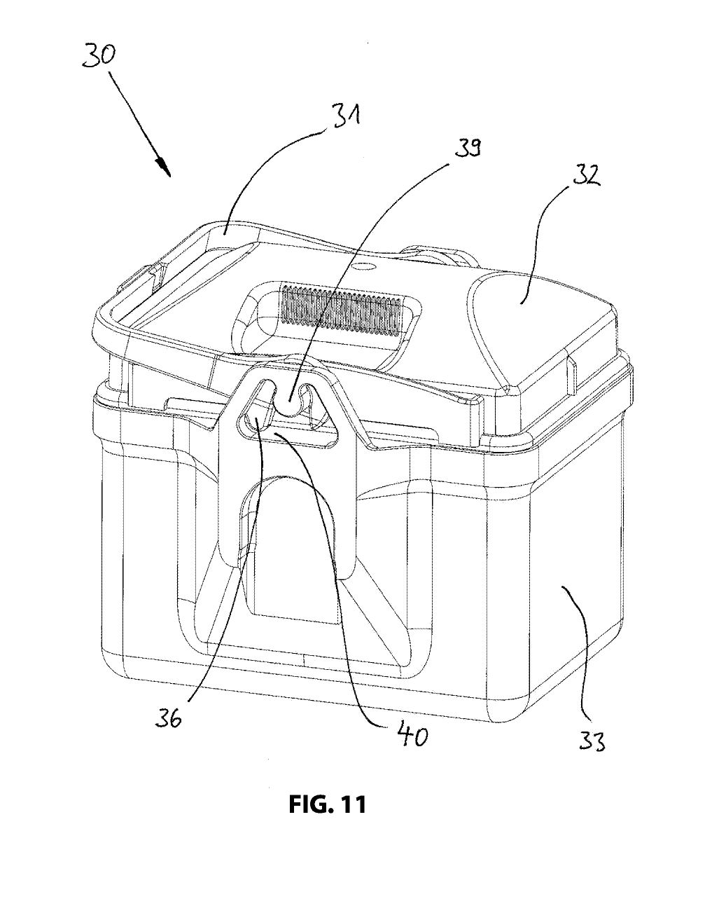

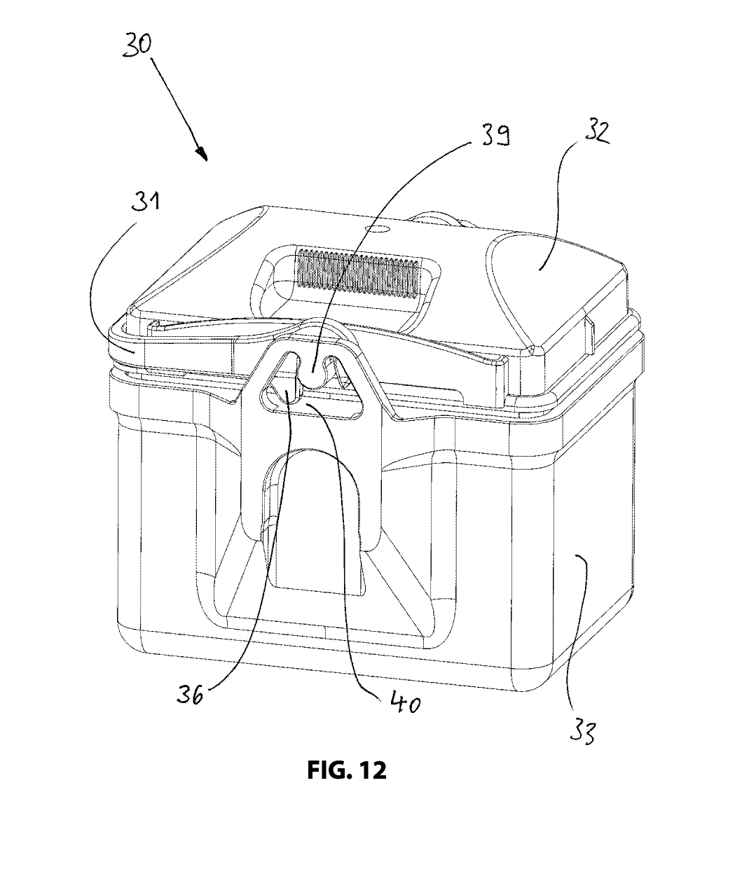

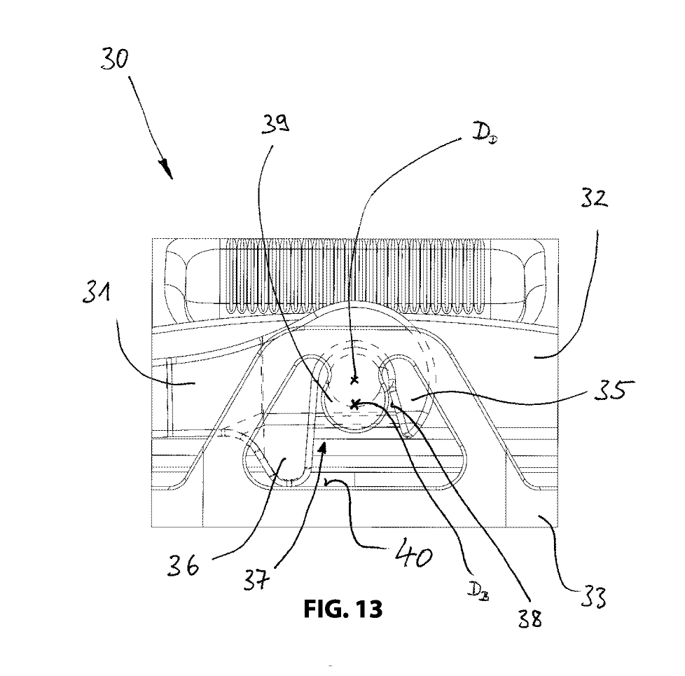

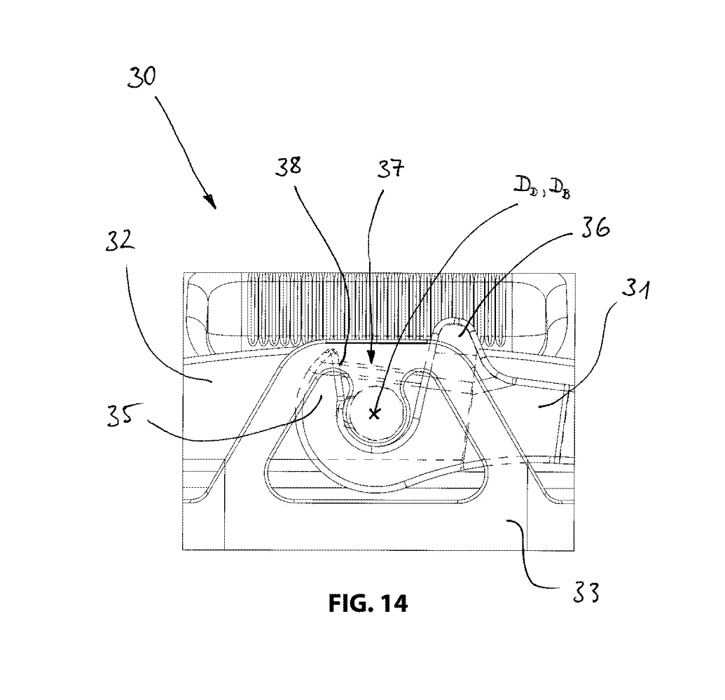

FIG. 9 illustrates a horizontal position of the handle 31 in which the cover 32 safely closes the container 33 and the handle 31 is fixated at the interlocking lug 34. FIG. 10 illustrates the vertical position of the handle 31 in which the cover 32 safely closes the container 33 and the handle 31 can be used for removing the centrifuge bucket 30 from the centrifuge and for carrying it. FIG. 11 illustrates a transition position of the handle 31 shortly before the other horizontal position illustrated in FIG. 12 in which the centrifuge bucket 30 is open and the cover 32 can be removed from the container 33. FIG. 13 illustrates an enlarged detail of FIG. 12 regarding the interaction between handle 31, cover 32 and container 33, and FIG. 14 illustrates an enlarged detail of FIG. 9 with respect to the interaction between handle 31, cover 32 and container 33. For better understanding, some covered elements are drawn in dashed lines.

It is apparent that the handle 31 includes a short lug 35 and a long lug 36 with a guide track 37 defined between the two lugs, wherein the guide track extends approximately perpendicular to the extension of the handle 31. As apparent in particular from FIG. 13, the short lug 35 has a slant angle 38 with reference to the long lug 36, wherein the short lug reaches behind the support element (not shown) of the rotating closure 39 during the closing process when the handle 31 is rotated and the support element lowers the cover 32 relative to the rotating closure 39 through the wedge effect which provides the closing force. An additional eccentric arrangement of the rotation axis D_{D} of the handle 31 relative to the cover 32 with the rotation axis D_{B} of the handle 31 relative to the rotating closure 39 or the container 33 is thus not required (c.f. FIG. 14), but can be additionally provided.

It is apparent from FIGS. 11, 12 and 13 that the long lug 36 contacts the top side 40 of the container 33 during the opening process and pivoting the handle 31 further causes the disengaging force component acting against the closing force which facilitates removing the cover 32 from the container 33. It is especially apparent in FIG. 13 that the long lug 36 acts against the surface 40 which moves the rotation axis D_{D} of the handle 31 at the cover 32 relative to the rotation axis of the handle 31 at the container in a vertical upward direction, wherein the disengagement of the cover 32 from the container 33 is forced. Contrary thereto, FIG. 14 illustrates the completely closed and locked condition according to FIG. 9 in an enlarged detail which makes apparent that the two rotation axes D_{D}, D_{B} coincide in this condition. This concentricity of the rotation axes D_{D} and D_{B} is only obviated through contact of the long lug 36 at the surface according to FIG. 10.

From the illustration provided supra, it is apparent that the centrifuge bucket 1, 30, according to the invention can be operated in a very simple manner and facilitates constant closure of the centrifuge bucket 1, 30 over its service life. Thus, the centrifuge bucket 1, 30 can be handled much better, because it facilitates real one hand operation without using the second hand. Furthermore the centrifuge bucket 1, can be manufactured in a simpler and more cost-effective manner while being equally suitable for a particular centrifugation power and centrifugation capacity.

This is significantly different from the known centrifuge buckets DE 1 0128 539 A1 and DE 10 2008 031 502 A1 because therein initially the cover itself has to be arranged, centered and pressed onto the container before the handle can interlock and be pivoted. Furthermore the known centrifuge buckets are configured much more complex and cumbersome because they include components that protrude beyond the bucket and which can easily lead to impairments when using the centrifuge buckets. By comparison the centrifuge bucket 1, 30 according to the invention is very simple in configuration and does not include components protruding beyond the bucket contour. Also the disadvantages of DE 10 2008 031 502 A1 with respect to service life are overcome, because the contours of guide track 18, 37 and guide element 24 can be configured so that no wear is present which would lead to a decrease of the clamping sooner or later.

What is claimed is:

1. A centrifuge bucket, comprising:
a container;
a cover;
at least one handle arranged at the cover; and
closure devices corresponding to one another that are arranged respectively at the handle and at the container so that a clamping force is generated in a closed condition of the centrifuge bucket and the cover is pressed onto the container,
wherein the at least one handle includes at least one first closure device which interacts with at least one second closure device arranged at the container to provide the clamping force for closing the centrifuge bucket,
wherein the at least one first closure device arranged at the at least one handle is configured as a guide track and the at least one second closure device arranged at the container is configured as a guide element, and
wherein the guide element is engageable in the guide track to provide the clamping force.

2. The centrifuge bucket according to claim 1, wherein the at least one handle is configured detachable from the cover.

3. The centrifuge bucket according to claim 1,
wherein the at least one handle rotates about a first rotation axis relative to the cover which differs from a second rotation axis of the at least one handle relative to the container, and
wherein the first rotation axis of the at least one handle at least in open condition of the centrifuge bucket is arranged relative to the cover with reference to a longitudinal extension of the centrifuge bucket above the second rotation axis of the at least one handle relative to the container.

4. The centrifuge bucket according to claim 1,
wherein the at least one handle is supported at two rotation points at the cover, and
wherein the corresponding closure devices at the container and at the at least one handle are associated with each rotation point or the at least one handle is configured as a pivotable lever.

5. The centrifuge bucket according to claim 1,
wherein the at least one handle is rotatable into a position in which the centrifuge bucket is closed and the at least one handle is usable as a carrying handle.

6. The centrifuge bucket according to claim 1,
wherein the at least one handle includes a stop which acts in a first rotation direction and prevents a rotation of the at least one handle beyond the stop in the first rotation direction.

7. The centrifuge bucket according to claim 6,
wherein the stop is configured so that it provides a force component when the at least one handle is rotated against the stop, and
wherein the force component is oriented opposite to the clamping force in order to disengage the cover from the container.

8. The centrifuge bucket according to claim 1,
wherein the centrifuge bucket includes locking devices for locking the at least one handle in the closed condition of the centrifuge bucket.

9. The centrifuge bucket according to claim 8,
wherein the locking devices are configured at the cover, so that the at least one handle is engageable with at least one additional element of the cover in a friction locking or form locking manner.

10. The centrifuge bucket according to claim 1,
wherein the container includes an edge enveloping the cover in a closed condition of the centrifuge bucket, and
wherein the edge of the container has a contour that expands conically towards the cover or the cover includes a contour that tapers conically in a direction towards the container.

11. The centrifuge bucket according to claim 2,
wherein the at least one handle rotates about a first rotation axis relative to the cover which differs from a second rotation axis of the at least one handle relative to the container, and
wherein the first rotation axis of the at least one handle at least in open condition of the centrifuge bucket is arranged relative to the cover with reference to a longitudinal extension of the centrifuge bucket above the second rotation axis of the at least one handle relative to the container.

12. The centrifuge bucket according to claim 11,
wherein the at least one handle is supported at two rotation points at the cover,
wherein the corresponding closure devices at the container and at the at least one handle are associated with each rotation point or the at least one handle is configured as a pivotable lever,
wherein the at least one handle is rotatable into a position in which the centrifuge bucket is closed and the at least one handle is usable as a carrying handle, and
wherein the at least one handle includes a stop which acts in a first rotation direction and prevents a rotation of the at least one handle beyond the stop in the first rotation direction.

13. The centrifuge bucket according to claim 12,
wherein the stop is configured so that it provides a force component when the at least one handle is rotated against the stop, and
wherein the force component is oriented opposite to the clamping force in order to disengage the cover from the container.

14. The centrifuge bucket according to claim 13,
wherein the centrifuge bucket includes locking devices for locking the at least one handle in the closed condition of the centrifuge bucket.

15. The centrifuge bucket according to claim 14, wherein the locking devices are configured at the cover, so that the at least one handle is engageable with at least one additional element of the cover in a friction locking or form locking manner.

16. The centrifuge bucket according to claim 1,
wherein the container includes an edge enveloping the cover in a closed condition of the centrifuge bucket, and
wherein the edge of the container has a contour that expands conically towards the cover or the cover includes a contour that tapers conically in a direction towards the container.
